(19) United States
(12) Patent Application Publication
(10) Pub. No.: US 2025/0174657 A1
(43) Pub. Date: May 29, 2025

(54) NEGATIVE ELECTRODE FOR BATTERY AND BATTERY

(71) Applicant: TOYOTA JIDOSHA KABUSHIKI KAISHA, Toyota-shi (JP)

(72) Inventor: Takeshi ABE, Toyota-shi (JP)

(73) Assignee: TOYOTA JIDOSHA KABUSHIKI KAISHA, Toyota- (JP)

(21) Appl. No.: 18/946,107

(22) Filed: Nov. 13, 2024

(30) Foreign Application Priority Data
Nov. 28, 2023 (JP) 2023-201069

(51) Int. Cl. H01M 4/583; H01M 4/02; H01M 4/36

(52) U.S. Cl. CPC H01M 4/583; H01M 4/366; H01M 2004/027

(57) ABSTRACT

A negative electrode for a battery includes a first negative electrode active material layer containing a first graphite having an aspect ratio of 2 to 5 and a second graphite having an aspect ratio of 1 to 1.4, wherein a peak intensity ratio determined through X-ray diffraction (XRD) measurement is 0.03 or more, and a current collector.

### CROSS-REFERENCE TO RELATED APPLICATION

This application claims priority to Japanese Patent Application No. 2023-201069 filed on Nov. 28, 2023, incorporated herein by reference in its entirety.

### BACKGROUND

### 1. Technical Field

The present disclosure relates to a negative electrode for a battery and a battery.

### 2. Description of Related Art

In recent years, the weight per unit area of an active material in an electrode of a secondary battery such as a lithium ion battery has been increasing in order to achieve a high energy density and a low cost.

With such an electrode, the charge-discharge capacity at a high rate is greatly reduced. On the other hand, attempts have been reported to orient graphite, as a negative electrode active material, in a negative electrode in order to increase the charge-discharge capacity of a lithium ion battery (see Japanese Unexamined Patent Application Publication No. 2022-167890 (JP 2022-167890 A), for example).

### SUMMARY

However, the orientation of the graphite is less likely to be maintained after a pressing step in forming the negative electrode.

An issue to be address by an embodiment of the present disclosure is to provide a negative electrode for a battery having low electrical resistance, and a battery including the negative electrode for a battery.

Means for addressing the above issue include the following aspects.

<1> A negative electrode for a battery, including:
a first negative electrode active material layer containing a first graphite having an aspect ratio of 2 to 5 and a second graphite having an aspect ratio of 1 to 1.4, wherein a peak intensity ratio of I₁₁₀/I₀₀₂ determined through X-ray diffraction measurement is 0.03 or more; and
a current collector.
<2> negative electrode for a battery according to <1>, in which a mass ratio of the second graphite to the first graphite in the first negative electrode active material layer is 30/70 to 70/30.
<3> The negative electrode for a battery according to <1> or <2>, further including a second negative electrode active material layer provided between the first negative electrode active material layer and the current collector, containing the second graphite, and not containing the first graphite.
<4> The negative electrode for a battery according to any one of <1> to <3>, in which the first negative electrode active material layer is provided as an outermost layer.
<5> A battery including the negative electrode for a battery according to any one of <1> to <4>.

According to the present disclosure, a negative electrode for a battery having low electrical resistance and a battery including the negative electrode for a battery are provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating an exemplary configuration of a negative electrode for a battery according to the present disclosure; and

FIG. 2 is a schematic cross-sectional view showing another example of the structure of the negative electrode for a battery according to the present disclosure.

### DETAILED DESCRIPTION OF EMBODIMENTS

Hereinafter, embodiments of the present disclosure will be described. The description is illustrative of the embodiments and is not intended to limit the scope of the disclosure.

In the present specification, a numerical range indicated by using “from” indicates a range including the numerical values described before and after “from” as the minimum value and the maximum value, respectively.

In the numerical ranges described in the present specification in a stepwise manner, the upper limit value or the lower limit value described in one numerical range may be replaced with the upper limit value or the lower limit value of the numerical range described in another stepwise manner. In addition, in the numerical range described in the present specification, the upper limit value or the lower limit value of the numerical range may be replaced with the value shown in the examples.

As used herein, the term “step” is included in this term not only as an independent step, but also as long as the intended purpose of the step is achieved even if it is not clearly distinguishable from other steps.

In the present specification, when an embodiment is described with reference to the drawings, the configuration of the embodiment is not limited to the configuration shown in the drawings. In addition, the sizes of the members in the drawings are conceptual, and the relative relationships of the sizes between the members are not limited thereto.

In the present specification, each component may include a plurality of corresponding substances. When the amount of each component in the composition is referred to in the present embodiment, when a plurality of substances corresponding to each component are present in the composition, the total amount of the plurality of substances present in the composition is meant unless otherwise specified.

As used herein, the term “aspect ratio” refers to the ratio of the major axis to the minor axis (major axis/minor axis) in a graphite particle, wherein an aspect ratio of 1 means a perfect circle.

Specifically, the “aspect ratio” when used with respect to the first graphite, refers to the length b of the short axis of the rectangular parallelepiped circumscribing the graphite particles (including the secondary particles), the ratio b/c when the thickness c. Further, when the second graphite is used, the length a of the long axis of the cubic or rectangular parallelepiped circumscribing the graphite particles (including secondary particles), a specific a/b when the length b of the short axis.

As used herein, the term “collapse” refers to the loss of orientation of graphite particles oriented along the vertical direction.

As used herein, “particle size” means the volume-averaged median diameter D₅₀.

### <Negative Electrode for a Battery>

The negative electrode for a battery of the present disclosure (hereinafter, also simply referred to as “negative electrode”) includes a first negative electrode active material layer containing a first graphite having an aspect ratio of 2 to 5 and a second graphite having an aspect ratio of 1 to 1.4, wherein a peak intensity ratio (I₁₁₀/I₀₀₂) determined through X-ray diffraction (XRD) measurement is 0.03 or more, and a current collector.

With the above configuration, even after the pressing step performed in the process of manufacturing the electrode, it is possible to maintain the orientation of graphite (graphite having a shape such as a scaly shape, a flat plate shape, or an elliptical shape) having a high aspect ratio in the negative electrode. Accordingly, a negative electrode for a battery having a low electrical resistance is provided. As a result, a battery having a high energy density can be obtained.

The reason why the above action can be obtained is presumed as follows.

The graphite having a high aspect ratio oriented in the vertical direction in the electrode (in particular, the surface layer of the electrode) is likely to expand or contract in the in-plane direction during charging and discharging, and thus the penetration path of ions into the electrode is likely to be secured, which is considered to be because the graphite has a low resistance.

Hereinafter, the configuration of the negative electrode will be described.

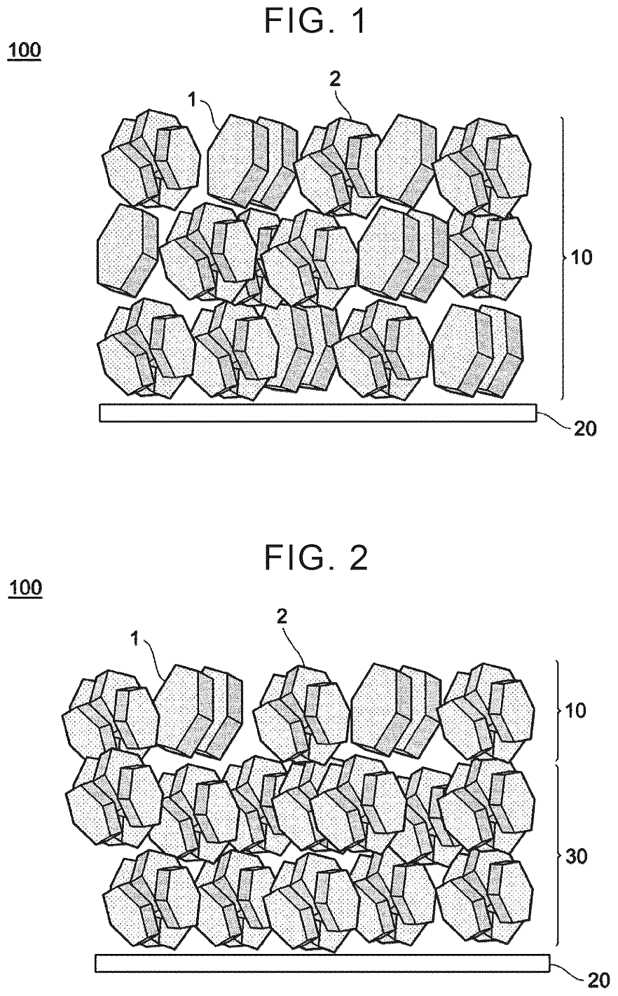

FIG. 1 is a schematic cross-sectional view illustrating an example of a structure of a battery negative electrode according to an embodiment of the battery negative electrode of the present disclosure. As illustrated in FIG. 1, a negative electrode 100 for a battery includes a first negative electrode active material layer 10 and a current collector 20. The first negative electrode active material layer 10 includes a first graphite 1 having a high aspect ratio and a second graphite 2 having a low aspect ratio.

### First Negative Electrode Active Material Layer

The first negative electrode active material layer includes first graphite and second graphite. The aspect ratio of the first graphite is 2 to 5. The aspect ratio of the second graphite is from 1 to 1.4. Since the aspect ratio of the first graphite is 2 to 5, when a magnetic field is applied to the first negative electrode active material layer, the first graphite is easily oriented in the vertical direction of the negative electrode. Further, the aspect ratio of the second graphite is 1 to 1.4, further, by being included with the first graphite in the first negative electrode active material layer, easily suppress collapse of the first graphite oriented by a magnetic field during pressing. Therefore, the orientation of the first graphite is maintained even after the pressing step. For example, when the aspect ratio of the second graphite is 1, the second graphite is spherical, and the second graphite does not collapse, and the collapse of the first graphite is suppressed.

The first graphite and the second graphite may be natural graphite or artificial graphite. The natural graphite may be scaly graphite or earth graphite.

The shapes of the first graphite and the second graphite are not particularly limited as long as they satisfy the aspect ratio described above. The shape of the first graphite includes a flat plate shape (for example, a scaly shape, an elliptical shape), and the like. Further, the shape of the second graphite includes a spherical shape (for example, a true spherical shape, an elliptical spherical shape), and the like.

The particle size of the first graphite and the second graphite may be from 0.1 μm to 100 μm.

The specific surface area of the first graphite and the second graphite may be from 0.1 m²/g to 1,500 m²/g.

In the first negative electrode active material layer, the mass ratio of the second graphite to the first graphite (mass % of the second graphite/mass % of the first graphite) is preferably 30/70 to 70/30. When the mass ratio of the second graphite to the first graphite (mass % of the second graphite/mass % of the first graphite) is 30/70 to 70/30, collapse of the first graphite is more easily suppressed in the first negative electrode active material layer, and the orientation is easily maintained. Therefore, when the battery (cell) is configured, the trapping property and the releasing property of ions (for example, lithium ions) are increased, so that the cell resistance is decreased and the capacity of the battery is easily increased.

The first negative electrode active material layer may include a binder and a conductive material in addition to the first graphite and the second graphite (not shown in FIG. 1).

Examples of the binder include polyvinylidene fluoride (PVDF)/NMP based, styrene-butadiene rubber (SBR)/water based, polytetrafluoroethylene (PTFE)/water-based binder, and the like. The binder may comprise carboxymethyl cellulose (CMC) as a thickener.

The content of the binder may be 0.1% by mass to 5% by mass with respect to the total amount of the first graphite and the second graphite.

Examples of the conductive agent include carbon materials such as acetylene black, Ketjen black, vapor-phase carbon fiber (VGCF (registered trademark)), and carbon nanotube (CNT).

The content of the conductive agent may be 0.1% by mass to 5% by mass with respect to the total amount of the first graphite and the second graphite.

### Current Collector

As the current collector, a known one may be used. For example, Cu, Al, Fe, Co, Ni, Cr, Ni plated steel, may be appropriately selected from those made of metallic members such as stainless steel. The negative electrode current collector is preferably made of Cu.

The thickness of the current collector is not particularly limited. For example, it may be 0.1 μm to 1000 μm.

The negative electrode for a battery of the present disclosure is obtained by providing a first negative electrode active material layer on a current collector. In an embodiment of the negative electrode for a battery of the present disclosure, the first negative electrode active material layer is provided on the current collector. More specifically, the negative electrode for a battery of the present disclosure can be manufactured, for example, by coating a slurry for forming a first negative electrode active material layer including first graphite and second graphite on a current collector, applying a magnetic field, drying, and pressing.

The slurry can be prepared by kneading a first graphite, a second graphite, a binder, and, if necessary, a conductive agent, a thickener, and the like.

The kneading may be performed by a known method. For example, planetary mixer, sand mill, ball mill, planetary mill, roll mill, may be performed using an extruder or the like.

The coating may be performed by a known method. For example, it may be performed by a slit die method, a doctor roll method, or the like.

The magnetic field may be applied by a known method. For example, it may be performed using a magnetizing device. By applying a magnetic field to the slurry, the first graphite in the first negative electrode active material layer can be oriented.

When the magnetic field is applied, the strength of the magnetic field is not particularly limited as long as the first graphite in the first negative electrode active material layer is oriented. For example, it may be 0.5 T or more.

When the magnetic field is applied, the direction of the magnetic field is not particularly limited as long as the first graphite in the first negative electrode active material layer is oriented. However, since the orientation of the first graphite is an embodiment suitable for increasing the trapping property and the releasing property of lithium ions, it is preferable to apply a magnetic field in a direction perpendicular to the plane of the negative electrode. As a result, the cell resistance is also easily reduced, and the capacity of the lithium ion battery is also easily increased.

Further, drying may be performed by a known method. For example, it may be performed by natural drying, vacuum drying, or heat drying. The drying temperature may be, for example, 80° C. to 135° C.

Further, the pressing may be performed by a known method. For example, it may be performed by roll pressing, cold isostatic pressing (CIP), or the like. Pressing may be performed, for example, to achieve an electrode density of 1.2 g/cm³.

A peak intensity ratio (I₁₁₀/I₀₀₂) determined by measuring XRD of the first negative electrode active material layer of the negative electrode for batteries disclosed herein is 0.03 or more. Referring to the Inorganic Crystal Structure Database (ICSD), the peak intensity ratio (I₁₁₀/I₀₀₂) of graphitic powder that is randomly oriented is 0.014. Therefore, the peak intensity ratio (I₁₁₀/I₀₀₂) is greater than 0.014, the first graphite is oriented in the in-plane direction of the graphene layered structure. Therefore, when the peak intensity ratio (I₁₁₀/I₀₀₂) is 0.03 or higher, the trapping property and the releasing property of ions (for example, lithium ions) are increased in the battery, the cell resistance is decreased, and the capacity of the battery is also easily increased.

XRD is measured by an XRD measuring device (CuK_{α}=1.5405 Å) is used. The peak intensity ratio (I₁₁₀/I₀₀₂) is obtained from the diffraction peak intensity I₀₀₂ attributed to the surface index (002) near 2θ=26.3° obtained by XRD determination (in the direction perpendicular to the surface of the graphene structure), and the diffraction peak intensity I₁₁₀ attributed to the surface index (110) near 2θ=77.7° (in the in-plane direction of the graphene structure).

The negative electrode for a battery of the present disclosure preferably further includes a second negative electrode active material layer including the second graphite and not including the first graphite between the first negative electrode active material layer and the current collector.

FIG. 2 is a schematic cross-sectional view illustrating an example of a structure of a battery negative electrode according to another embodiment of the battery negative electrode of the present disclosure. As illustrated in FIG. 2, the negative electrode 100 for a battery includes a second negative electrode active material layer 30 between the first negative electrode active material layer 10 and the current collector 20. By further including the second negative electrode active material layer 30, the diffusivity of ions (for example, lithium ions) is more likely to be improved than in the case where the negative electrode is formed of the second negative electrode active material layer alone. The negative electrode for a battery of FIG. 2 can be manufactured by providing a second negative electrode active material layer on a current collector and further providing a first negative electrode active material layer thereon. In particular, an embodiment in which the first negative electrode active material layer, the second negative electrode active material layer, and the current collector, which are the outermost layers, are provided in this order is preferable for the same reason as described above.

### Second Negative Electrode Active Material Layer

The second negative electrode active material layer preferably contains second graphite as the negative electrode active material and does not contain first graphite, and more preferably contains only second graphite.

The second negative electrode active material layer may contain a binder and a conductive agent in addition to the second graphite (not shown in FIG. 2).

As the binder, the same binder as that exemplified for the first negative electrode active material layer can be used. The content of the binder may be the same as that exemplified for the first negative electrode active material layer.

As the conductive agent, the same materials as those exemplified in the first negative electrode active material layer can be used. The content of the conductive agent may be the same as that exemplified for the first negative electrode active material layer.

### Battery

The battery of the present disclosure includes the negative electrode for a battery. The battery of the present disclosure preferably has a laminated structure in which the negative electrode and the positive electrode are laminated with an electrolyte layer interposed therebetween. The battery of the present disclosure is preferably a secondary battery, and more preferably a lithium ion secondary battery.

### Positive Electrode

The positive electrode includes a positive electrode active material layer and a current collector.

The positive electrode active material layer preferably includes a positive electrode active material, a conductive agent, and a binder.

Examples of the positive electrode active material include layered, olivine-based, and spinel-based compounds, and examples thereof include lithium composite oxides. Examples of the lithium complex oxide include lithium cobaltate, lithium nickelate, lithium manganate, and LiNi_{1/3}Co_{1/3}Mn_{1/3}O₂. Examples of the layered lithium-composite oxide include a compound represented by the compositional LiNiₓMe¹_{y}Me²_{z}O₂. Where Me¹ includes Co, Fe, Mn, Mo and the like, Me² includes Al, Ga, Si, Mg, Ti, Ba, Zr, Y, and the like, x, y, and z are integers greater than or equal to 0, and x+y+z=1. Examples of the olivine-based lithium complex oxide include LiFePO₄, LiFe₁₋ₓMnₓPO₄ (x is an integer of 0 or more). Examples of the spinel-based lithium complex oxide include LiMn₂O₄. The lithium-composite oxide may contain at least one selected from the group consisting of F, Cl, N, S, Br, and I.

The shape of the positive electrode active material is not particularly limited. For example, it may be spherical (e.g., true spherical, elliptical spherical, etc.), fibrous, etc.

The particle size of the positive electrode active material may be 0.1 μm to 30 μm.

The specific surface area of the positive electrode active material may be from 0.1 m²/g to 100 m²/g.

As the conductive agent, the same materials as those exemplified for the negative electrode can be used. The content of the conductive agent may be 3% by mass to 5% by mass with respect to the positive electrode active material.

As the binder, the same binder as that exemplified for the negative electrode can be used. The content of the binder may be 0.1% by mass to 5% by mass with respect to the positive electrode active material.

### Current Collector

As the current collector, those exemplified by the negative electrode can be used. The positive electrode current collector is preferably made of Al.

The thickness of the current collector is not particularly limited. For example, it may be 0.1 μm to 1000 μm.

### Electrolyte Layer

The electrolyte layer may include a solid electrolyte layer or a separator and an electrolyte.

When the electrolyte layer is a solid electrolyte layer, examples of the solid electrolyte include oxide solid electrolytes such as lithium lanthanum zirconate, LiPON, Li₁₊ₓAlₓGe₂₋ₓ(PO₄)₃, Li—SiO-based glass, and Li—Al—S—O-based glass; sulfide solid electrolytes such as Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅, LizS—P₂S₅—GeS₂. The solid electrolyte layer can be obtained by pressing the solid electrolyte.

When the electrolyte layer includes a separator and an electrolyte solution, examples of the separator include a resin-sheet such as polyethylene (PE) and polypropylene (PP). Also, the electrolyte solution includes a predetermined electrolyte and a solvent. Examples of the predetermined electrolytes include LiPF₆, LiBF₄, LiAsF₆, Li(CF₃SO₂)₂N, Li(C₂F₅SO₂)₂N, LiTaF₆, LiClO₄, LiCF₃SO₃.

Examples of the solvent include cyclic carbonate-based solvents such as ethylene carbonate (EC) and propylene carbonate (PC); and linear carbonate-based solvents such as dimethyl carbonate (DMC), diethyl carbonate (DEC), and ethyl methyl carbonate (EMC). The electrolyte may be 0.1 to 1 mol/L in concentration.

Hereinafter, the present disclosure will be described in detail with reference to Examples, but the present disclosure is not limited to the following Examples. Production of Negative Electrodes

### Example 1

A first graphite with an aspect ratio of 2 to 5 and a second graphite with an aspect ratio of 1 to 1.4 were used. To a graphite mixture having a blending ratio of first graphite:second graphite=70:30 (mass ratio), carboxymethyl cellulose (CMC) as a thickener and styrene butadiene rubber (SBR) as a binder were added so as to have a first graphite and a second graphite: CMC:SBR=98:1:1 (mass ratio). Further, water was added and kneaded to prepare a slurry for forming the first negative electrode active material layer. Next, the slurry was coated on a current collector (Cu foil) so that the basis weight was 20 mg/cm², and when the orientation treatment was performed on the slurry, a magnetic field of 0.5 T or more was applied to the surface of the first negative electrode active material layers.

Next, the first negative electrode active material layer was dried and pressed to produce a negative electrode with an electrode density of 1.2 g/cm³.

### Evaluation of the Negative Electrode

### XRD Measurement

With respect to the prepared negative electrode, the orientation of the first graphite in the first negative electrode active material layers was evaluated by the peak intensity ratio obtained by XRD measuring.

XRD measurement was performed using an XRD measuring device (CuK_{α}=1.5405 Å). The orientation of the first graphite was evaluated by the ratio (I₁₁₀/I₀₀₂) of the diffraction peak intensity I₀₀₂ assigned to the surface index (002) near 2θ=26.3° (the direction perpendicular to the graphene structure) and the diffraction peak intensity I₁₁₀ assigned to the surface index (110) near 2θ=77.7° (the in-plane direction of the graphene structure). The results are shown in Table 1.

### Cell Resistance

The performance of the negative electrode was evaluated by half-cell using Li as a counter electrode. Specifically, the negative electrode was cut out at a 5 cm angle (excluding the current collector tab), and the negative electrode was made to face Li via a three-layer separator having a PP/PE/PP of 20 μm, and laminated and sealed with EC/EMC=30/70 (volume %) containing 1MLiPF₆ to prepare a half-cell. The half-cell was charged and discharged in the range of 0.05 V to 1.2 V (vs. Li/Li⁺), and SOC 100% was defined based on the capacity at that time. After the cell was adjusted to SOC 50%, the cell was charged with 1 C for 10 minutes, and the cell resistance was calculated by dividing the absolute value of the voltage change (the open circuit voltage after 10 minutes before evaluation) at that time by 1 C current value. The results are shown in Table 1. Note that each resistance value is indicated by a standard value based on the resistance of Comparative Example 2.

### Example 2

In Example 1, a negative electrode was prepared and evaluated in the same manner as in Example 1, except that the first negative electrode active material layer having the blending ratio shown in Table 1 was provided on the current collector. The results are shown in Table 1.

### Example 3

In Example 1, a negative electrode was prepared and evaluated in the same manner as in Example 1, except that the first negative electrode active material layer having the blending ratio shown in Table 1 was provided on the current collector. The results are shown in Table 1.

### Example 4

Graphite with an aspect ratio of 1 to 1.4 (second graphite), carboxymethyl cellulose (CMC) as a thickener, and styrene-butadiene rubber (SBR) as a binder are added so as to have graphite: CMC:SBR=98:1:1 (mass ratio). A slurry for forming the second negative electrode active material layer was prepared by adding water and kneading. In Example 1, a negative electrode was prepared and evaluated in the same manner as in Example 1, except that a slurry for forming the second negative electrode active material layer was coated on a current collector (Cu foil), and a first negative electrode active material layer having a blending ratio shown in Table 1 was further provided thereon. The results are shown in Table 1.

### Comparative Example 1

In Example 1, a negative electrode was fabricated and evaluated in the same manner as in Example 1, except that the current collector was provided with the first negative electrode active material layer having the blending ratio shown in Table 1 and no magnetic field was applied. The results are shown in Table 1.

### Comparative Example 2

In Example 1, a negative electrode was prepared and evaluated in the same manner as in Example 1, except that the first negative electrode active material layer having the blending ratio shown in Table 1 was provided on the current collector. The results are shown in Table 1.

### Comparative Example 3

In Example 1, a negative electrode was prepared and evaluated in the same manner as in Example 1, except that the first negative electrode active material layer having the blending ratio shown in Table 1 was provided on the current collector. The results are shown in Table 1.

### Comparative Example 4

In Example 1, a negative electrode was prepared and evaluated in the same manner as in Example 1, except that the first negative electrode active material layer having the blending ratio shown in Table 1 was provided on the current collector. The results are shown in Table 1.

TABLE 1

| | Graphite blending | | Magnetic | | |
|---|---|---|---|---|---|
| | ratio (% by mass) | Basis | field | | Cell |
| | (second graphite/ | weight | applica- | I₁₁₀/ | resis- |
| | the first graphite) | (mg/cm²) | tion | I₀₀₂ | tance |
| Example 1 | 30/70 | 20 | Found | 0.042 | 0.76 |
| Example 2 | 50/50 | 20 | Found | 0.051 | 0.72 |
| Example 3 | 70/30 | 20 | Found | 0.03 | 0.8 |
| Example 4 | Upper layer) | 20 | Found | 0.045 | 0.75 |
| | 50/50 lower | | | | |
| | layer) 100/0 | | | | |
| Comparative | 0/100 | 20 | None | 0.001 | — |
| Example 1 | | | | | |
| Comparative | 0/100 | 20 | Found | 0.011 | 1 |
| Example 2 | | | | | |
| Comparative | 10/90 | 20 | Found | 0.015 | 0.97 |
| Example 3 | | | | | |
| Comparative | 90/10 | 20 | Found | 0.019 | 1.03 |
| Example 4 | | | | | |

As shown in Table 1, in the case where the mass ratio of the second graphite to the first graphite (mass % of the second graphite/mass % of the first graphite) is 30/70 to 70 in the first negative electrode active material layer (Examples 1 to 4), the mass ratio of the first graphite and the second graphite does not include the second graphite, or the mass ratio of the first graphite and the second graphite deviates from the above range (Comparative Examples 2 to 4). The I₁₁₀/I₀₀₂ has increased significantly. It was confirmed that collapse of the first graphite by the press was suppressed. Increased I₁₁₀/I₀₀₂ correlated with a decrease in cell resistance, and in Examples 1 to 4, a decrease in cell resistance of 20% to 30% was observed compared to the case without the second graphite (Examples 1 to 4, Comparative Example 2).

On the other hand, in Comparative Example 3 in which the mass ratio of the second graphite to the first graphite (mass % of the second graphite/mass % of the first graphite) was 10/90, the I₁₁₀/I₀₀₂ did not significantly increase. In Comparative Example 4 in which the mass ratio of the second graphite to the first graphite (mass % of the second graphite/mass % of the first graphite) was 90/10, the I₁₁₀/I₀₀₂ did not significantly increase. In the case of Comparative Example 4, it is considered that the ratio of the first graphite oriented by the magnetic field is small.

Further, although the first graphite is once oriented when a magnetic field is applied (Comparative Examples 1 and 2), the I₁₁₀/I₀₀₂ is smaller than 0.014 that is the I₁₁₀/I₀₀₂ of graphite powder randomly oriented, indicating that pressing causes the first graphite to be oriented in a collapsed orientation in the in-plane direction of the negative electrode.

What is claimed is:

1. A negative electrode for a battery comprising:
a first negative electrode active material layer containing a first graphite having an aspect ratio of 2 to 5 and a second graphite having an aspect ratio of 1 to 1.4, wherein a peak intensity ratio of I₁₁₀/I₀₀₂ determined through X-ray diffraction measurement is 0.03 or more; and
a current collector.

2. The negative electrode according to claim 1, wherein a mass ratio of the second graphite to the first graphite in the first negative electrode active material layer is 30/70 to 70/30.

3. The negative electrode according to claim 1, further comprising a second negative electrode active material layer provided between the first negative electrode active material layer and the current collector, containing the second graphite, and not containing the first graphite.

4. The negative electrode according to claim 3, wherein the first negative electrode active material layer is provided as an outermost layer.

5. A battery comprising the negative electrode according to claim 1.
